(19) United States
(12) Patent Application Publication
(10) Pub. No.: US 2016/0048253 A1
(43) Pub. Date: Feb. 18, 2016

(54) TOUCH DISPLAY DEVICE

(71) Applicant: InnoLux Corporation, Miao-Li County (TW)

(72) Inventors: Jian-Cheng CHEN, Miao-Li County (TW); Chia-Sen CHANG, Miao-Li County (TW); Chih-Chiang CHANG CHIEN, Miao-Li County (TW); Ren-Lung CHEN, Miao-Li County (TW); Hang-Lang LEE, Miao-Li County (TW); Hong-Sheng HSIEH, Miao-Li County (TW)

(21) Appl. No.: 14/806,856

(22) Filed: Jul. 23, 2015

(30) Foreign Application Priority Data
Aug. 15, 2014 (TW) 103128085

(51) Int. Cl. G06F 3/041

(52) U.S. Cl. CPC G06F 3/0412

(57) ABSTRACT

A touch display device is disclosed, which comprises: a display; a touch panel disposed on the display; and a protective layer disposed on the touch panel, wherein at least one of the high refractive layer is disposed between the protective layer and the touch panel, and the high refractive layer has a refractive index greater than 1.5 and less than 2.0.

### CROSS REFERENCE TO RELATED APPLICATION

This application claims the benefits of the Taiwan Patent Application Serial Number 103128085, filed on Aug. 15, 2014, the subject matter of which is incorporated herein by reference.

### BACKGROUND OF THE INVENTION

1. Field of the Invention

The disclosure relates to a touch display device, and especially to a touch display device capable of reducing the visibility of electrode patterns.

2. Description of Related Art

In recent years, with the development trend of user-friendly operation and simplification, touch display devices are more and more widely used in life. Since users can input signal to the touch panel by a hand directly or other objects, users' dependence on other input devices (such as a keyboard, a mouse, and a remote control, etc.) is reduced or even eliminated, and users' convenience is increased dramatically.

A typical touch panel unit includes a sensing electrode array having a plurality of sensing electrodes arranged in series along the vertical and horizontal directions, metal bridges for electrically connecting the sensing electrodes, and an insulating layer disposed therebetween. A cover glass is necessary to be disposed on the touch panel for protection, and an adhesive can be used to replace the traditional border sticker for a phone screen to achieve full lamination of the cover glass and the touch panel. The use of adhesive can avoid the air gap caused by the border sticker, and effectively improve the display quality of the touch panel. Nowadays, common adhesives are, for example, an optical clear adhesive (OCA), an optical clear resin (OCR) and the like.

Although the adhesive can improve the display quality of the touch panel, it, however, makes the electrode array pattern of the touch panel more observable by the human eye, causing the visibility problem. Therefore, what is needed in the art is to develop a touch display device, which can alleviate the visibility problem of the electrode pattern to enhance user's visual quality.

### SUMMARY OF THE INVENTION

The disclosure is to provide a touch display device capable of effectively solving the visibility problem of the electrode pattern.

To achieve the above object, the disclosure provides a touch display device, comprising: a display; a touch panel disposed on the display; and a protective layer disposed on the touch panel; wherein at least one of the high refractive layer is disposed between the protective layer and the touch panel, and the high refractive layer has a refractive index greater than 1.5 and less than 2.0.

Accordingly, in the touch display device of the disclosure, the high refractive layer is disposed between the protective layer and the touch panel to reduce the difference between the refractive indexes of the touch panel and the high refractive layer and substantially reduce the refraction and reflection phenomenon while light penetrates the panel, thereby effectively alleviating the visibility problem of the electrode pattern.

### BRIEF DESCRIPTION OF THE DRAWINGS

FIG. 1A shows a schematic diagram of the touch display device according to Embodiment 1.

FIG. 1B shows a schematic diagram of another touch display device according to Embodiment 1.

FIG. 1C shows a schematic diagram of a further touch display device according to Embodiment 1.

FIG. 2A shows a schematic diagram of the touch display device according to Embodiment 2.

FIG. 2B shows a schematic diagram of another touch display device according to Embodiment 2.

FIG. 3A shows a schematic diagram of the touch display device according to Embodiment 3.

FIG. 3B shows a schematic diagram of another touch display device according to Embodiment 3.

FIG. 3C shows a schematic diagram of the polarizer in FIGS. 3A and 3B.

### DETAILED DESCRIPTION OF THE PREFERRED EMBODIMENT

Hereafter, examples will be provided to illustrate the examples of the disclosure. Other advantages and effects of the invention will become more apparent from the disclosure of the disclosure. Other various aspects also may be practiced or applied in the invention, and various modifications and variations can be made without departing from the spirit of the invention based on various concepts and applications.

### Embodiment 1

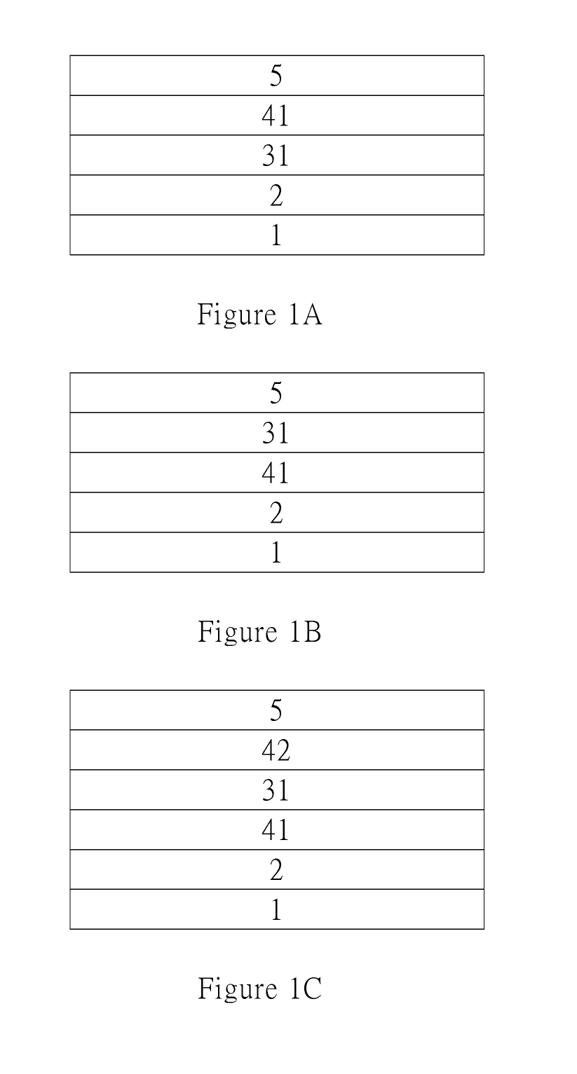

FIG. 1A shows a schematic diagram of the touch display device according to a preferred example of the disclosure. The touch display of the disclosure comprises: a display 1; a touch panel 2 disposed on the display 1; and a protective layer 5 disposed on the touch panel 2; wherein a polarizer 31 and an adhesive layer 41 are disposed between the protective layer 5 and the touch panel 2. The adhesive layer 41 is a high refractive layer disposed on a surface of the protective layer 5 and has a refractive index greater than 1.5 and less than 2.0, and more preferably determined in accordance with the refractive index of the touch panel 2. The difference between the refractive indexes of the adhesive layer 2 and the touch panel 41 is preferably between 0 and 1, and more preferably the touch panel 2 and the adhesive layer 41 have the same refractive index.

In the present embodiment, the adhesive layer 41 is an optical clear adhesive (OCA), but the disclosure is not limited thereto. When the refractive index of the adhesive layer 41 is greater than 1.5 and less than 2.0, the adhesive layer 41 may be any conventional adhesive layer, such as an optical clear resin (OCR) layer.

In the present embodiment, the adhesive layer 41 is disposed on a surface of the protective layer 5. However, the adhesive layer 41 may also be disposed on a surface of the touch panel 2, as shown in FIG. 1B. Alternatively, the touch display device of the disclosure may include a plurality of the adhesive layers. Referring to FIG. 1C, the touch display device of the disclosure includes the adhesive layer 41 and an additional adhesive layer 42, and the adhesive layer 41 may also be disposed on a surface of the touch panel 2, while the additional adhesive layer 42 is disposed on a surface of the protective layer 5. In addition, a polarizer 31 is disposed between the adhesive layer 41 and the additional adhesive layer 42.

In the present embodiment, the display 1, the touch panel 2, the polarizer 31, and the protective layer 5 may be conventional elements known in the art. For example, the display 1 may be a liquid crystal display device (LCD) or an organic light-emitting diode device (OLED), the touch panel 2 may be a capacitive or resistive touch panel, the polarizer may be a linear or transmissive polarizer, and the protective layer 5 may be a glass layer.

### Embodiment 2

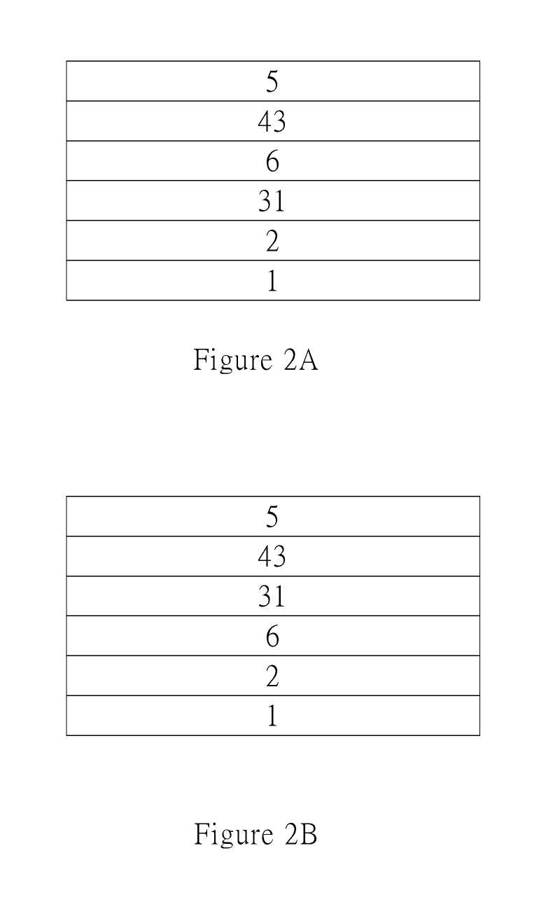

FIG. 2A shows a schematic diagram of the touch display device according to another preferred embodiment of the disclosure. The touch display of the disclosure comprises: a display 1; a touch panel 2 disposed on the display 1; and a protective layer 5 disposed on the touch panel 2; wherein a polarizer 31, a coating layer 6 and an adhesive layer 43 are disposed between the protective layer 5 and the touch panel 2. The polarizer 31 is disposed on the touch panel 2, and the coating layer 6 is formed on a surface of the polarizer 31 which is a high refractive layer and has a refractive index greater than 1.5 and less than 2.0. Preferably, the refractive index of the coating layer 6 is in a range from 1.68 to 1.78, and more preferably determined in accordance with the refractive index of the touch panel 2. The difference between the refractive indexes of the adhesive layer 2 and the coating layer 6 is preferably between 0 and 1, and more preferably the touch panel 2 and the coating layer 6 have the same refractive index.

In the present embodiment, the polarizer 31 is disposed on the touch panel 2, and the coating layer 6 is formed on a surface of the polarizer 31. However, the coating layer 6 may also be formed on another surface of the polarizer 31. As shown in FIG. 2B, the coating layer 6 is located between the touch panel 2 and the polarizer 31. Alternatively, if necessary, the touch display device of the disclosure may contain a plurality of coating layers 6.

In the present embodiment, the coating layer 6 may be formed by coating any material having a refractive index greater than 1.5 and less than 2.0. The adhesive layer 43 is not particularly limited, and may be any adhesive layer known in the art. Furthermore, the display 1, the touch panel 2, the polarizer 31, and the protective layer 5 are the same as those illustrated in Embodiment 1, and will not be repeated herein.

### Embodiment 3

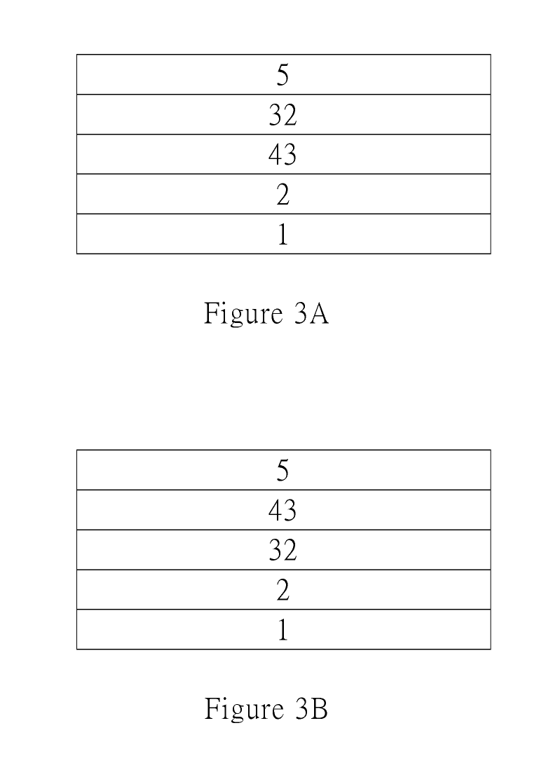

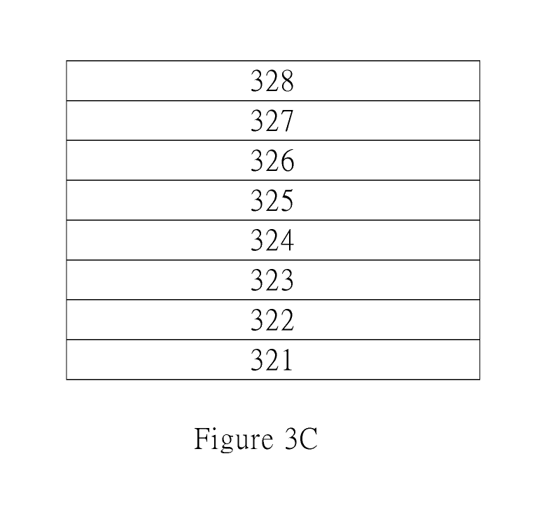

FIG. 3A shows a schematic diagram of the touch display device according to another preferred embodiment of the disclosure. The touch display of the disclosure comprises: a display 1; a touch panel 2 disposed on the display 1; and a protective layer 5 disposed on the touch panel 2; wherein a polarizer 32 and an adhesive layer 43 are disposed between the protective layer 5 and the touch panel 2. The polarizer 32 is a high refractive layer and has a refractive index greater than 1.5 and less than 2.0, and more preferably determined in accordance with the refractive index of the touch panel 2. The difference between the refractive indexes of the adhesive layer 2 and the polarizer 32 is preferably between 0 and 1, and more preferably the touch panel 2 and the polarizer 32 have the same refractive index.

In the present embodiment, the polarizer 32 is provided on a surface of the protective layer 5. However, the polarizer 32 may also be disposed on a surface of the touch panel 2, as shown in FIG. 3B. In the present embodiment, the polarizer 32 may be any known polarizer having a refractive index greater than 1.5 and less than 2.0. FIG. 3C shows an exemplary structure of the polarizer. The polarizer 32 includes a protective film 321, a first triacetate cellulose (TAC) film 322, a first adhesive 323, a polyvinyl alcohol (PVA) film 324, a second adhesive 325, a second triacetate cellulose (TAC) film 326, a third adhesive 327 and the separator 328, wherein the refractive index of each component in the polarizer 32 may be adjusted, respectively, in order to achieve the overall refractive index of the polarizer 32 to be greater than 1.5 and less than 2.0; but the disclosure is not limited thereto.

In the present embodiment, the adhesive layer 43 is not particularly limited, and may be any adhesive layer known in the art. Furthermore, the display 1, the touch panel 2, the polarizer 31, and the protective layer 5 are the same as those illustrated in Embodiment 1, and will not be repeated herein.

Accordingly, when the light penetrates the panel, the above described configurations can significantly reduce the phenomenon of refraction and reflection to improve the visibility of the electrode pattern, and give consumers a better user experience.

The above examples are only for the purpose of better describing the disclosure and are of exemplary nature, the scope of right asserted by the disclosure is based on the scope of claims in this application, and are not intended to be limited by the above examples.

What is claimed is:

1. A touch display device, comprising:
a display;
a touch panel disposed on the display; and
a protective layer disposed on the touch panel,
wherein at least one of the high refractive layer is disposed between the protective layer and the touch panel, and the high refractive layer has a refractive index greater than 1.5 and less than 2.0.

2. The touch display device of claim 1, wherein at least one of the high refractive layer comprises a polarizer disposed on a surface of the protective layer.

3. The touch display device of claim 1, wherein at least one of the high refractive layer comprises a polarizer disposed on a surface of the touch panel.

4. The touch display device of claim 1, wherein at least one of the high refractive layer comprises an adhesive layer disposed on a surface of the protective layer.

5. The touch display device of claim 1, wherein at least one of the high refractive layer comprises an adhesive layer disposed on a surface of the touch panel.

6. The touch display device of claim 1, wherein at least one of the high refractive layer comprises a plurality of adhesive layers.

7. The touch display device of claim 6, wherein a polarizer is disposed between the adhesive layers.

8. The touch display device of claim 5, wherein the adhesive layer is an optical clear adhesive (OCA), or an optical clear resin (OCR).

9. The touch display device of claim 6, wherein the adhesive layer is an optical clear adhesive (OCA), or an optical clear resin (OCR).

10. The touch display device of claim 7, wherein the adhesive layer is an optical clear adhesive (OCA), or an optical clear resin (OCR).

11. The touch display device of claim 8, wherein the adhesive layer is an optical clear adhesive (OCA), or an optical clear resin (OCR).

12. The touch display device of claim 1, wherein a difference between the refractive index of the touch panel and the refractive index of the high refractive layer is 0-1.

13. The touch display device of claim 12, wherein the touch panel and the high refractive layer have the same refractive index.
